(19) United States
(12) Patent Application Publication
(10) Pub. No.: US 2017/0359471 A1
(43) Pub. Date: Dec. 14, 2017

(54) IMAGING APPARATUS

(71) Applicant: CANON KABUSHIKI KAISHA, Tokyo (JP)

(72) Inventor: Hideki Kadoi, Tokyo (JP)

(21) Appl. No.: 15/615,982

(22) Filed: Jun. 7, 2017

(30) Foreign Application Priority Data
Jun. 14, 2016 (JP) 2016-118042

(51) Int. Cl. H04N 1/00; H04N 5/232; G06T 7/20

(52) U.S. Cl. CPC H04N 1/00127; G06T 7/20; H04N 5/23216; H04N 5/23293

(57) ABSTRACT

An imaging apparatus according to the present invention includes: an imaging unit configured to generate RAW image data by imaging; a generation unit configured to generate record RAW image data from the RAW image data; and a recording unit configured to record in a storage unit the record RAW image data, wherein the generation unit generates the record RAW image data by performing Lossy compression on the RAW image data in a case where consecutive shooting is performed, and generates the record RAW image data by performing Lossless compression on the RAW image data in a case where single shooting or bracket photographing is performed.

### BACKGROUND OF THE INVENTION

### Field of the Invention

The present invention relates to an imaging apparatus.

### Description of the Related Art

In a general imaging apparatus, developed image data is generated by performing development processing of the RAW image data generated by an image sensor. Then the developed image data is compression-encoded, and the compression-encoded developed image data is recorded in a recording medium (e.g. memory card). The developed image data is, for example, image data of which each pixel value includes the brightness value and the color difference value (e.g. YCbCr image data), image data of which each pixel value includes a plurality of gradation values corresponding to a plurality of primary colors (e.g. RGB image data) and the like. The development processing generally includes a debayer processing (demosaic processing) to convert the RAW image data into the developed image data, a noise removal processing to remove noise, a distortion correction processing to correct optical distortion, and an optimization processing to optimize the image.

On the other hand, there is an imaging apparatus that can record the RAW image data. The data size of the RAW image data is much larger than the data size of the developed image data, but the image quality of the RAW image data is also much higher than the image quality of the developed image data. If the imaging apparatus that can record the RAW image data is used, the RAW image data can be edited after photographing. Therefore use of an imaging apparatus that can record the RAW image data is preferred by experts.

An imaging apparatus that records the RAW image data is disclosed in Japanese Patent Application Laid-open No. 2014-179851. The imaging apparatus disclosed in Japanese Patent Application Laid-open No. 2014-179851 can execute two types of development processing: simple development processing and high image-quality development processing. In the high image-quality processing, developed image data, which has image quality that is higher than the image quality of the developed image data acquired by the simple development processing, can be acquired. The processing load of the high image-quality development processing is larger than the processing load of the simple development processing, and the processing time of the high image-quality development processing is longer than the processing time of the simple development processing. This means that the high image-quality development processing during photographing drops in photographic performance. In the case of the image apparatus disclosed in Japanese Patent Application Laid-open No. 2014-179851, the RAW image data is recorded and the simple development processing is performed at photographing, and the high image quality development processing is performed at reproducing. Thereby the above mentioned drop in photographic performance can be suppressed.

However, a factor causing a drop in photographic performance is not only the length of the processing time of the development processing. As mentioned above, the data size of the RAW image data is very large. Therefore it takes a long time to write the RAW image data to the recording medium. This long write time to write data (write time) drops the photographic performance. In other words, the length of the write time is also a factor in dropping photographic performance.

The drop in photographic performance due to the length of the write time will now be described in concrete terms. In the case of single shooting, where photographing is performed only once, the time interval between a plurality of times of photographing (single shooting) is generally long, hence there is a slight drop in photographic performance due to the length of the write time. On the other hand, in the case of consecutive shooting, where a plurality of times of photographing are performed consecutively, the time interval of a plurality of times of photographing is short, hence a drop in photographic performance due to the length of the write time is hard to occur. In concrete terms, the speed to acquire the RAW image data from the image sensor must be controlled not to exceed the speed of writing the RAW image data to the recording medium, therefore the consecutive shooting speed is decreased. In other words, a number of times of photographing per unit time is reduced.

### SUMMARY OF THE INVENTION

The present invention provides a technique to improve the photographic performance.

The present invention in its first aspect provides an imaging apparatus, comprising:
an imaging unit configured to generate RAW image data by imaging;
a generation unit configured to generate record RAW image data from the RAW image data; and
a recording unit configured to record in a storage unit the record RAW image data, wherein
the generation unit
generates the record RAW image data by performing Lossy compression on the RAW image data in a case where consecutive shooting is performed, and
generates the record RAW image data by performing Lossless compression on the RAW image data in a case where single shooting or bracket photographing is performed.

The present invention in its second aspect provides an imaging method, comprising:
generating RAW image data by imaging;
generating record RAW image data from the RAW image data; and
recording in a storage unit the record RAW image data, wherein
the record RAW image data is generated by performing Lossy compression on the RAW image data in a case where consecutive shooting is performed, and
the record RAW image data is generated by performing Lossless compression on the RAW image data in a case where single shooting or bracket photographing is performed.

The present invention in its third aspect provides a non-transitory computer readable medium that stores a program, wherein
the program causes a computer to execute:
generating RAW image data by imaging;
generating record RAW image data from the RAW image data; and
recording in a storage unit the record RAW image data,
the record RAW image data is generated by performing Lossy compression on the RAW image data in a case where consecutive shooting is performed, and
the record RAW image data is generated by performing Lossless compression on the RAW image data in a case where single shooting or bracket photographing is performed.

According to the present invention, the photographic performance can be improved.

Further features of the present invention will become apparent from the following description of exemplary embodiments with reference to the attached drawings.

### BRIEF DESCRIPTION OF THE DRAWINGS

FIG. 1 is an example of the configuration of an imaging apparatus according to Embodiment 1 and Embodiment 2;

FIG. 2 is an example of the processing flow of the imaging apparatus according to Embodiment 1 and Embodiment 2;

FIG. 3 is an example of RAW compression according to Embodiment 1; and

FIG. 4A to FIG. 4C are examples of RAW compression (for consecutive shooting) according to Embodiment 2.

### DESCRIPTION OF THE EMBODIMENTS

### Embodiment 1

Embodiment 1 of the present invention will be described.

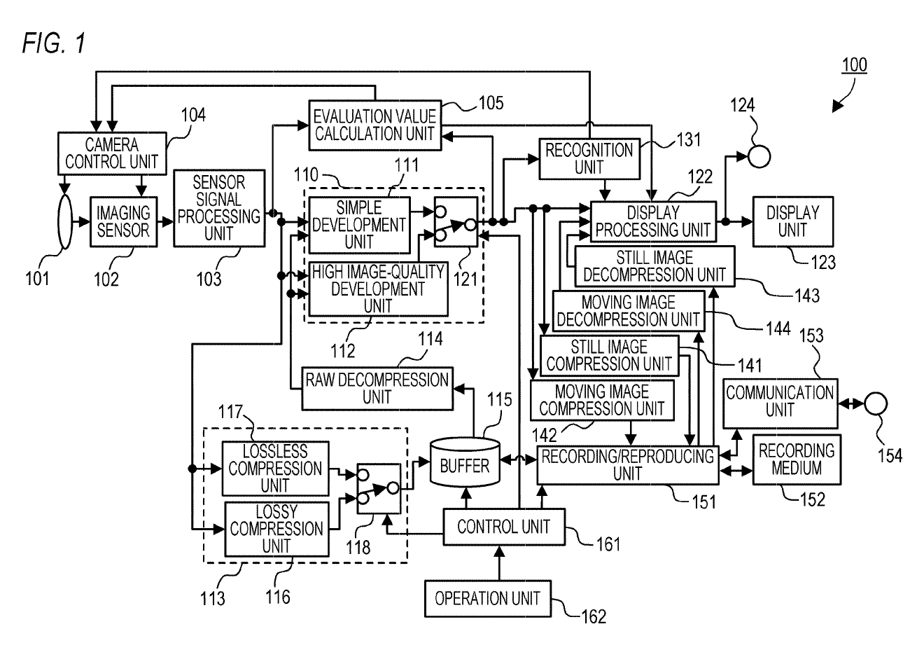

FIG. 1 is a block diagram depicting a configuration example of an imaging apparatus 100 according to this embodiment. The imaging apparatus 100 has a recording function, a reproducing function, a communication function, an image processing function, an editing function and the like. The recording function is a function to record imaging data generated by imaging (image data representing an object). The reproducing function is a function to read the recorded imaging data, and display an image based on the read imaging data. The communication function is a function to communicate with an external device (e.g. server (cloud)) of the imaging apparatus 100. The image processing function is a function to perform image processing (e.g. development processing) of the imaging data. The editing function is a function to edit the imaging data.

Therefore the imaging apparatus 100 can also be called a “recording apparatus”, a “reproducing apparatus”, “a recording/reproducing apparatus”, a “communication apparatus”, an “image processing apparatus”, an “editing apparatus” and the like. If the imaging apparatus 100 is used in a system constituted by a plurality of apparatuses, this system can be called a “recording system”, a “reproducing system”, a “recording/reproducing system”, a “communication system”, an “image processing system”, an “editing system” and the like.

In this embodiment, a processing for an imaging sensor 102 to convert the light from an object into electric signals is called “imaging”. And a processing from the imaging to the display (display of an image based on imaging data), a processing from the imaging to the recording (recording imaging data) and the like are called “photographing”.

In FIG. 1, a control unit 161 controls the overall processing of the imaging apparatus 100. For example, the control unit 161 has a CPU and a memory in which a control program is stored (not illustrated). The overall processing of the imaging apparatus 100 is controlled by the CPU reading the control program stored in memory, and executing the program.

The operation unit 162 receives an instruction from the user to the imaging apparatus 100 (user operation). The operation unit 162 has an input device, such as a keypad, buttons and a touch panel. The operation unit 162 outputs an operation signal in accordance with the user operation. The control unit 161 detects the operation signal outputted from the operation unit 162, and controls the processing of the imaging apparatus 100 (the processing by each functional unit of the imaging apparatus 100), so that the processing in accordance with the user operation is executed.

The display unit 123 displays an image based on the imaging data, the menu screen, various information and the like. For the display unit 123, a liquid crystal display panel, an organic EL display panel, a plasma display panel or the like is used.

In a case where photographing starts, the light from an object, which is an imaging target, is irradiated to the imaging sensor 102 via an optical unit 101 constituted by a plurality of lenses. Thereby an optical image of the object is formed on the imaging sensor 102 (image formation). During photographing, the state of the optical unit 101 and the processing of the imaging sensor 102 are controlled by a camera control unit 104. The camera control unit 104 controls the state of the optical unit 101 and the processing of the imaging sensor 102 based on, for instance, a user operation, a result of an evaluation value calculation processing of an evaluation value calculation unit 105, and a result of a recognition processing of a recognition unit 131.

The imaging sensor 102 generates RAW image data by imaging, and outputs the generated RAW image data. For example, the imaging sensor 102 has a mosaic color filter, and the light from the optical unit 101 transmits through the mosaic color filter. The imaging sensor 102 converts the light transmitted through the mosaic color filters into an electric signal, which is the RAW pixel data. The mosaic color filters has: a color filter corresponding to red (R color filter), a color filter corresponding to green (G color filter), and a color filter corresponding to blue (B color filter) for each pixel, for example. The R color filters, the G color filters and the B color filters are arranged in a mosaic. The imaging sensor 102 can generate a RAW image data corresponding to such resolutions as 4K (8 million pixels or more) and 8K (33 million pixels or more).

A sensor signal processing unit 103 performs repair processing of the RAW image data outputted from the imaging sensor 102, and outputs the repaired RAW image data. By repair processing, pixel values of missing pixels in the RAW image data outputted from the imaging sensor 102 are generated, and pixel values of which reliability is low in the RAW image data outputted from the imaging sensor 102 are corrected. The repair processing includes, for example, interpolation processing using pixel values of the pixels that exist around processing target pixels (e.g. missing pixels, pixels of which reliability is low), and offset processing to subtract a predetermined offset value from a pixel value of a processing target pixel. Part or all of the repair processing may be performed during development processing.

A development unit 110 generates developed image data by performing the development processing of the RAW image data. The development unit 110 outputs the generated developed image data. The developed image data is, for example, image data of which each pixel value includes a brightness value and a color difference value (e.g. YCbCr image data), or image data of which each pixel value includes a plurality of gradation values corresponding to a plurality of primary colors respectively (e.g. RGB image data). The development processing includes a debayer processing (demosaic processing) to convert the RAW image data into the developed image data, a noise removal processing to remove noise, a distortion correction processing to correct optical distortion, and an optimization processing to optimize the image. The debayer processing can also be called “demosaic processing”, “color interpolation processing” or the like.

The development unit 110 performs the development processing of the RAW image data outputted from the sensor signal processing unit 103, and performs the development processing of the RAW image data outputted from a RAW decompression unit 114. For example, in the case of photographing which does not include recording of the imaging data, the development unit 110 performs the development processing of the RAW image data outputted from the sensor signal processing unit 103. “photographing which does not include recording of the imaging data” is, for example, “photographing which includes a display to visually check the state of the object in real-time”. “photographing which includes a display to visually check the state of the object in real-time” can also be “photographing which uses the display unit 123 (or a display device) as an electronic view finder”. In the case of photographing which includes recording of the imaging data, the development unit 110 performs the development processing of the RAW image data which is outputted from the RAW decompression unit 114. The development unit 110 also performs the development processing of the RAW image data which is outputted from the RAW decompression unit 114 at reproduction, in which the recorded RAW image data is read and the image is displayed based on the RAW image data.

The development unit 110 has a simple development unit 111, a high image-quality development unit 112, and a switch 121. The simple development unit 111 and the high image-quality development unit 112 respectively perform the development processing of the RAW image data, so as to generate the development image data and output the generated developed image data. Hereafter the development processing executed by the simple development unit 111 is called “simple development processing”, and the development processing executed by the high image-quality development unit 112 is called “high image-quality development processing”. The switch 121 selects either the developed image data generated by the simple development unit 111 or the developed image data generated by the high image-quality development unit 112, and outputs the selected developed image data. The control unit 161 outputs an instruction to the switch 121 based on the user operation, an operation mode which is set in the imaging apparatus 100, and the like. The developed image data, which is selected by the switch 121, is switched in accordance with the instruction from the control unit 161.

The high image-quality development processing is a higher resolution development processing than the simple development processing. Therefore in the high image-quality development processing, the acquired developed image data has a higher image quality than the image quality of the developed image data acquired by the simple development processing. However, the processing load of the high image-quality development processing is higher than the processing load of the simple development processing, and the processing time of the high image-quality development processing is longer than the processing time of the simple development processing.

As mentioned above, the processing load of the high image-quality development processing is large, and the processing time of the high image-quality development processing is long. This means that the high image-quality development processing is not desirable for the development processing during photographing, including the display to visually check the state of the object in real-time. The processing load of the simple development processing, on the other hand, is small, and the processing time of the simple development processing is short. This means that the simple development processing is preferable as the development processing during photographing, including the display to visually check the state of the object in real-time. Therefore in this embodiment, in a case where photographing, including the display to visually check the state of the object in real-time, is performed, the switch 121 selects the developed image data generated by the simple development processing. Thereby delays in generating the display image to visually check the state of the object in real-time can be reduced.

The simple development processing will be described in detail. In the simple development processing, the development processing is faster and more simplified by limiting the image size of the developed image data to a small size, and simplifying or omitting a part of the processing. As a result, photographing 60 frames at 2 million pixels per second, for example, can be implemented with a smaller circuit scale at low power consumption. “small size” here refers to, for instance, an image size having 2 million pixels or less, and “part of processing” refers to, for instance, at least one of the noise removal processing, distortion correction processing and optimization processing.

Further, as mentioned above, the processing resolution of the simple development processing is low. This means that the simple development processing is not desirable for development processing after photographing. “development processing after photographing” is, for example, “development processing to read the recorded RAW image data, and display an image based on the RAW image data”. The processing resolution of the high image-quality development processing, on the other hand, is high. This means that the high image-quality development processing is desirable for the development processing after photographing. Therefore in this embodiment, after photographing, the switch 121 selects the development image data generated by the high image-quality development processing. Thereby the user can visually check the high quality image after photographing.

In this embodiment, the development unit 110 has the simple development unit 111 and the high image-quality development unit 112, but one development processing unit, which can execute the simple development processing and the high image-quality development processing, may be used as the development unit 110. In the development unit 110, the simple development processing and the high image-quality development processing may or may not be executed in parallel. For example, only the development processing to generate the developed image data, which is outputted by the development unit 110, may be selected and executed. In the case where the development unit 110 has the simple development unit 111 and the high image-quality development unit 112, the processing of each development unit (executing/not executing the development processing) maybe independently controlled, interlocking with the switching of the switch 121. By selecting and executing one of the simple development processing and the high image-quality development processing, the maximum processing of the entire imaging apparatus 100 can be reduced, and the processing load of the imaging apparatus 100 can be reduced.

A display processing unit 122 generates display image data by performing predetermined display processing of the developed image data. Then the display processing unit 122 outputs the generated display image data to the display unit 123. Thereby an image based on the display image data is displayed on the display unit 123. In this embodiment, a display device, which is an external device of the imaging apparatus 100, can be connected to an output terminal 124 of the imaging apparatus 100. Further, the display processing unit 122 can also output the display image data to the display device via the output terminal 124. If the display image data is outputted to the display device, an image based on the display image data is displayed on the display device. A general purpose interface such as an HDMI® terminal and an SDI terminal may be used for the output terminal 124. In the case where the display device is always used, the imaging apparatus 100 need not include the display unit 123. The display device can be connected to the imaging apparatus 100 via a cable, or may be connected wirelessly to the imaging apparatus 100.

The display processing unit 122 performs the display processing of the developed image data outputted from the development unit 110, performs the display processing of the developed image data outputted from a still image decompression unit 143, or performs the display processing of the developed image data outputted from a moving image decompression unit 144. For example, during photographing, the display processing unit 122 performs the display processing of the developed image data outputted from the development unit 110. During reproduction as well, in a case where the recorded RAW image data is read and an image based on the RAW image data is displayed, the display processing unit 122 performs the display processing of the developed image data outputted from the development unit 110. In a case where a recorded still image data (developed image data) is read and a still image based on the still image data is reproduced and displayed, the display processing unit 122 performs the display processing of the developed image data outputted from the still image decompression unit 143. In a case where a recorded moving image data (developed image data) is read and a moving image based on the moving image data is reproduced and displayed, the display processing unit 122 performs the display processing of the developed image data outputted from the moving image decompression unit 144.

The evaluation value calculation unit 105 calculates an evaluation value, which indicates a focus state, exposure state, camera shake state or the like, based on the developed image data outputted from the development unit 110 (evaluation value calculation processing). Then the evaluation value calculation unit 105 outputs the result of the evaluation value calculation processing. For example, the evaluation value calculation unit 105 outputs the calculated evaluation value as a result of the evaluation value calculation processing. The evaluation value calculation processing is performed only during photographing, for example. The evaluation value calculation unit 105 may perform the evaluation value calculation processing using the RAW image data, instead of the developed image data.

The recognition unit 131 detects and recognizes a predetermined image region from the image region of the developed image data, based on the developed image data outputted from the development unit 110 (recognition processing). The predetermined image region is, for example, an image region of a predetermined object (e.g. an individual, a face, an automobile, a building). In the recognition processing, a type (attribute) of a predetermined image region is recognized based on the characteristics of the predetermined image region. For example, a type of an object that exists in a predetermined image region is recognized. Then the recognition unit 131 outputs the result of the recognition processing. For example, the recognition unit 131 outputs information that includes the position information to indicate a position of the detected image region, the type information to indicate a type of the detected image region and the like, as the result of the recognition processing. The type information indicates, for example, an individual's name, a vehicle model name, a building name or the like. The recognition processing is performed only during photographing, for example. The recognition unit 131 may perform the recognition processing using the RAW image data, instead of the developed image data.

A still image compression unit 141 generates still image data (still image file), which is developed image data, by compressing the developed image data outputted from the development unit 110. Then the still image compress ion unit 141 outputs the generated still image data. A moving image compression unit 142 generates moving image data (moving image file), which is developed image data, by compressing the developed image data outputted from the development unit 110. Then the moving image compression unit 142 outputs the generated moving image data. In this embodiment, “compression” refers to the “compression of data size (information volume)”, and can also be called “high efficiency encoding” or “compression encoding”. The still image compression unit 141 performs JPEG type compression, for example. The moving image compression unit 142 performs compression specified by such standards as MPEG-2, H.264 or H265. The still image compression unit 141 performs compression, for instance, only in a case where photographing is performed to record the still image data, which is developed image data. The moving image compression unit 142 performs compression, for instance, only in a case where photographing is performed to record the moving image data, which is developed image data.

A RAW compression unit 113 generates record RAW image data from the RAW image data outputted from the sensor signal processing unit 103. In concrete terms, the RAW compression unit 113 generates the record RAW image data by compressing the RAW image data outputted from the sensor signal processing unit 103. The record RAW image data is RAW image data (RAW file). Then the RAW compression unit 113 stores the generated record RAW image data to a buffer (storage medium) 115. The record RAW image data is generated only in a case where photographing, to include the recording of the imaging data, is performed, for example.

The timing when the record RAW image data is deleted from the buffer 115 is not especially limited. For example, in a case where new record RAW image data cannot be stored to the buffer 115, unless the record RAW image data already stored (recorded) in the buffer 115 is deleted, the record RAW image data already stored is deleted from the buffer 115. If the record RAW image data, which is already stored in the buffer 115, is stored to another recording medium, this record RAW image data is deleted from the buffer 115.

The RAW compression unit 113 has a Lossy compression unit 116, a Lossless compression unit 117 and a switch 118. The Lossy compression unit 116 and the Lossless compression unit 117 respectively compress the RAW image data outputted from the sensor signal processing unit 103, and output the compressed RAW image data. The compression executed by the Lossy compression unit 116 is called “Lossy compression”, and the compression executed by the Lossless compression unit 117 is called “Lossless compression”. The switch 118 selects either the RAW image data after the Lossy compression or the RAW image data after the Lossless compression, and outputs the selected RAW image data as the record RAW image data. The control unit 161 outputs an instruction to the switch 118, in accordance with the user operation, an operation mode currently set in the imaging apparatus 100, and the like.

Then the RAW image data selected by the switch 118 is switched in accordance with the instruction from the control unit 161.

In this embodiment, the compression ratio R_Lossy of the Lossy compression is higher than the compression ratio R_Lossless of the Lossless compression. Therefore the RAW image data acquired after the Lossy compression is RAW image data of which data size is smaller than the data size of the RAW image data after the Lossless compression. The RAW image data acquired after the Lossless compression is the RAW image data of which image quality is higher than the image quality of RAW image data after the Lossy compression.

The compression method of the Lossless compression is not especially limited, and a compression method by which the RAW image data before compression can be restored without dropping the image quality (Lossless compression method), for example, can be used as the compression method of the Lossless compression. In concrete terms, a run-length compression, entropy encoding, LZW or the like can be used for the Lossless compression.

The compression method of the Lossy compression is not especially limited either, and a compression method by which deterioration of the image quality is obscured due to the visual characteristics of human eyes, for example, is used for the Lossy compression. In concrete terms, a wavelet transform, discrete cosine transform, Fourier transform or the like is performed for the Lossy compression. In these compression methods, the data size is reduced by deleting (decreasing) the high frequency components and low amplitude components which are hardly detectable by human senses. The compression method of the Lossy compression may be a compression method considering both the irreversible compression method (compression method by which RAW image data having lower image quality than the image quality of the RAW image data before compression is acquired as the restored RAW image data) and the reversible compression method. For example, the compression based on the Lossy compression method may be performed in a predetermined image region, and the compression based on the Lossless compression may be performed in an image region that is different from the predetermined image region.

In this embodiment, the RAW compression unit 113 has two compression units: the Lossy compression unit 116 and the Lossless compression unit 117, but one compression unit, which can execute the Lossy compression and the Lossless compression, may be used as the RAW compression unit 113. In the RAW compression unit 113, the Lossy compression and the Lossless compression mayor may not be executed in parallel. For example, only the compression to generate the RAW image data outputted by the RAW compression unit 113 may be selected and executed. In the case where the RAW compression unit 113 has the Lossy compression unit 116 and the Loss less compression unit 117, the processing of each compression unit (executing/not executing compression) may be independently controlled, interlocking with the switching of the switch 118. By selecting and executing one of the Lossy compression and the Lossless compression, the maximum processing of the entire imaging apparatus 100 can be decreased, and the processing load of the imaging apparatus 100 can be decreased.

A recording/reproducing unit 151, for instance, records imaging data and reads recorded imaging data. The recording/reproducing unit 151 can record the imaging data to a recording medium 152, or read the imaging data from the recording medium 152. The recording medium 152 is, for example, an internal semiconductor memory, an internal hard disk, a removable semiconductor memory (e.g. memory card), a removable hard disk or the like. The recording/reproducing unit 151 can also record the imaging data to an external device (e.g. server, storage device) via a communication unit 153 and a communication terminal 154, or read the imaging data from the external device via the communication unit 153 and the communication terminal 154. The communication unit 153 can access an external device by wireless communication or cable communication using the communication terminal 154.

For example, in photographing to record the record RAW image data, the recording/reproducing unit 151 reads the recorded RAW image data from the buffer 115, and records in the storage unit (recording medium 152 or external device) the read record RAW image data. In a case where photographing is performed to record still image data, which is developed image data, the recording/reproducing unit 151 records in the storage unit the still image data outputted from the still image compression unit 141. During photography to record moving image data, which is the developed image data, the recording/reproducing unit 151 records in the storage unit the moving image data outputted from the moving image compression unit 142.

In a case where the RAW image data is reproduced, the recording/reproducing unit 151 reads the RAW image data from the storage unit, and records the read RAW image data to the buffer 115. In a case where still image data, which is developed image data, is reproduced, the recording/reproducing unit 151 reads the still image data from the storage unit, and outputs the read still image data to the still image decompression unit 143. In a case where moving image data, which is developed image data, is reproduced, the recording/reproducing unit 151 reads the moving image data from the storage unit, and outputs the read moving image data to the moving image decompression unit 144.

The RAW decompression unit 114 reads the RAW image data from the buffer 115, and decompresses the read RAW image data. In this embodiment, “decompressing the RAW image data” refers to “restoring the RAW image data before compression by the RAW compression unit 113”, and “decompression” can also be called “decoding”. Then the RAW decompression unit 114 outputs the decompressed RAW image data to the development unit 110 (simple development unit 111 and high image-quality development unit 112). The decompression by the RAW decompression unit 114 is per formed only in a case where photographing, including the recording of the imaging data, is performed, and a case where the RAW data is reproduced.

The still image decompression unit 143 decompresses the still image data (developed image data) outputted from the recording/reproducing unit 151, and outputs the decompressed still image data to the display processing unit 122. “decompressing the still image data” refers to “restoring the developed image data before compression by the still image compression unit 141”. Decompression by the still image decompression unit 143 is performed, for instance, only in a case where the still image data, which is developed image data, is reproduced.

The moving image decompression unit 144 decompresses the moving image data (developed image data) outputted from the recording/reproducing unit 151, and outputs the decompressed moving image data to the display processing unit 122. “decompressing the moving image data” refers to “restoring the developed image data before compression by the moving image compression unit 142”. The decompression by the moving image decompression unit 144 is performed, for instance, only in a case where the moving image data, which is developed image data, is reproduced.

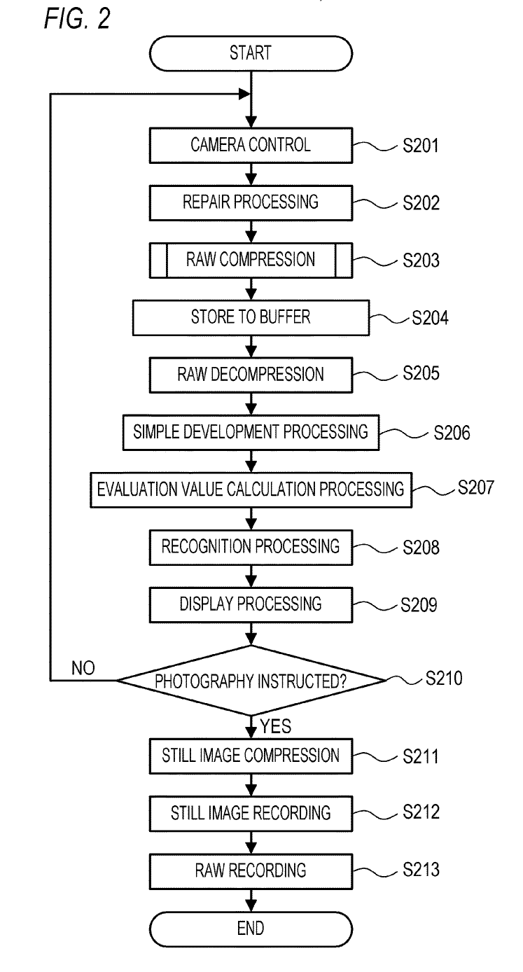

An example of the processing flow of the imaging apparatus 100 will be described next with reference to FIG. 2. FIG. 2 is an example of a processing flow in a case where the still image photographing mode is set. In the period when the still image photographing mode is set, the processing flow in FIG. 2 is executed repeatedly. The processing flow in FIG. 2 is implemented, for instance, by the control unit 161 controlling the processing of each functional unit. In concrete terms, the CPU of the control unit 161 reads a program from a memory (ROM) of the control unit 161, loads the read program in the memory (RAM), and executes the loaded program. Thereby the control unit 161 controls the processing of each functional unit, and the processing flow in FIG. 2 is implemented. In the following, an example, in a case where the development processing of the RAW image data outputted from the RAW decompression unit 114 is always performed by the development unit 110, will be described, but the development processing target may be appropriately switched, as mentioned above. For example, if the imaging data is not recorded, the development processing may be performed on the RAW image data outputted from the sensor signal processing unit 103.

First in step S201, the camera control unit 104 controls the state of the optical unit 101 and the processing of the imaging sensor 102, so that photographing is performed under desirable conditions. For example, if the user instructs for zoom adjustment or for focus adjustment to the imaging apparatus 100, the lens of the optical unit 101 is moved. If the user instructs the imaging apparatus 100 to change a number of the photographing pixels (number of pixels of recording target imaging data), a read region (region from which pixel values of the RAW image data are read) of the imaging sensor 102 is changed. As mentioned above, the state of the optical unit 101 and the processing of the imaging sensor 102 may be controlled based on the result of the evaluation value calculation processing of the evaluation value calculation unit 105 and the result of the recognition processing of the recognition unit 131. For example, based on the result of the evaluation value calculation processing and the result of the recognition processing of the recognition unit 131, a control to focus on a specific object, a control to track a specific object, a control to reduce camera shake, a control to change the diaphragm so as to implement a desired exposure state and the like, are performed.

Then in step S202, the sensor signal processing unit 103 performs repair processing of the RAW image data outputted from the imaging sensor 102. Then in step S203, the RAW compression unit 113 compresses the RAW image data repaired in step S202, whereby the record RAW image data is generated. The processing in step S203 will be described later in detail. Then in step S204, the RAW compression unit 113 stores the recoding RAW image data, generated in step S203, to the buffer 115. Then in step S205, the RAW decompression unit 114 reads the record RAW image data, stored in step S204, from the buffer 115, and decompresses the read record RAW image data.

Then in step S206, the simple development unit 111 performs the simple development processing of the record RAW image data decompressed in step S205, whereby the developed image data is generated. The state of the switch 121 of the development unit 110 at this time has been controlled to a state of selecting and outputting the developed image data of the simple development unit 111. Then in step S207, the evaluation value calculation unit 105 calculates the evaluation value based on the brightness value, the contrast value and the like of the developed image data generated in step S206. Then in step S208, based on the developed image data generated in step S206, the recognition unit 131 detects and recognizes a predetermined image region from the image region of the developed image data.

Then in step S209, the display processing unit 122 performs a predetermined display processing of the developed image data generated in S206, whereby the display image data is generated. The display image data generated in step S209 is used for a “live view display (camera through image display)” for the user to appropriately frame the object. The display processing unit 122 outputs the generated display image data to the display unit (display unit 123 or an external display device). Thereby an image based on the display image data is displayed on the display unit. The predetermined display processing may include a processing based on the result of the evaluation value calculation processing, the result of the recognition processing and the like. For example, the predetermined display processing may include processing to display markings on the focused region, processing to display a frame enclosing a recognized image region and the like.

Then in step S210, the control unit 161 determines whether the user sent a photographing instruction (recording instruction to record the imaging data) to the imaging apparatus 100, based on the operation signal from the operation unit 162. If the user sent the photographing instruction, processing advances to step S211, and if the user did not send the photographing instruction, processing returns to step S201. The timing to record the imaging data is not limited to the timing based on the user operation. For example, processing may advance automatically to step S201 or S211, so that the imaging data is recorded at a predetermined timing based on the operation mode or the like.

In step S211, the still image compression unit 141 compresses the developed image data generated in step S206, whereby the still image data is generated (still image compression). Then in step S212, the recording/reproducing unit 151 records in the storage unit (recording medium 152 or external device) the still image data generated in step S211. Finally in step S213, the recording/reproducing unit 151 reads the record RAW image data, stored instep S204, from the buffer 115, and records in the storage unit the read record RAW image data.

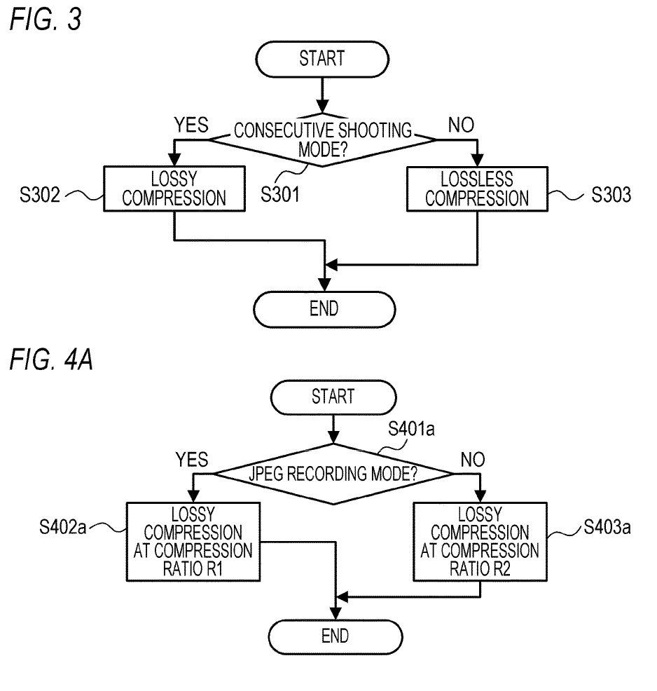

The processing in step S203 (RAW compression) will be described in detail with reference to FIG. 3. FIG. 3 is a flow chart depicting an example of the processing in step S203.

First in step S301, the control unit 161 determines whether the currently set still image photographing mode is the consecutive shooting mode. If the consecutive shooting mode is set, the control unit 161 controls the state of the switch 118 of the RAW compression unit 113 to the state to select and output the RAW image data after the Lossy compression, and processing advances to step S302. If the consecutive shooting mode is not set (if the currently set still image photographing mode is the single shooting mode), the control unit 161 controls the state of the switch 118 to the state to select and output the RAW image data after the Lossless compression, and processing advances to step S303. If the consecutive shooting mode is set, the consecutive shooting is performed based on the photographing instruction, and if the single shooting mode is set, the single shooting is performed based on the photographing instruction.

In the consecutive shooting, a plurality of times of photographing (photographing to record the imaging data) is performed consecutively. For example, if the consecutive shooting mode is set, the processing in steps S201 to S213 is repeated, so that the processing in step S213 is repeated consecutively based on one photographing instruction. The number of times the processing in step S213 is repeated consecutively is, for example, a predetermined number of times, or a number of times in accordance with the length of the period when the photographing instruction is sent. In the single shooting, the photographing to record the imaging data is executed only once. For example, if the single shooting mode is set, the processing in steps S201 to S213 is repeated, so that the processing in step S213 is performed only once based on one photographing instruction.

In this embodiment, the still image photographing modes that can be set are the consecutive shooting mode and the single shooting mode, but the present invention is not limited to this. For example, a number of types of still image photography modes that can be set may be one, or more than two. The photographing instructions that can be executed may include a consecutive shooting instruction to execute the consecutive shooting, a single shooting instruction to execute the single shooting and the like. The user operation corresponding to the consecutive shooting instruction is, for example, the user operation of depressing the shutter button longer than a predetermined time, and the user operation corresponding to the single shooting instruction is, for example, the user operation of depressing the shutter button for a time less than a predetermined time. In a case where the consecutive shooting is instructed, processing may advance from step S301 to step S302, and in a case where the single shooting is instructed, processing may advance from step S301 to step S303. In a case where the photographing is not instructed, processing may advance to step S302 or to step S303. However, in terms of reducing the processing load and decreasing the processing time, it is preferable to advance to step S302 in a case where the photographing is not instructed.

In step S302, the Lossy compression unit 116 of the RAW compression unit 113 compresses the RAW image data repaired in step S202 (Lossy compression). Then in step S203 of FIG. 2, the switch 118 selects the RAW image data after the Lossy compression in step S302, and outputs the selected RAW image data to the buffer 115 as the record RAW image data.

In step S303, the Lossless compression unit 117 of the RAW compression unit 113 compresses the RAW image data repaired in step S202 (Lossless compression). Then in step S203 in FIG. 2, the switch 118 selects the RAW image data after the Lossless compression in step S303, and outputs the selected RAW image data to the buffer 115 as the record RAW image data.

According to this embodiment, in the case of consecutive shooting in which a large volume of imaging data must be recorded in a short time, the RAW image data is compressed at a compression rate that is higher than the compression rate in the single shooting, as described above. Thereby the photographic performance can be improved. In concrete terms, in the case of the consecutive shooting, the data size of the RAW image data to be recorded can be reduced to a size that is smaller than the data size of the RAW image data recorded in the case of the single shooting. Thereby, in the case of the consecutive shooting, the recording time (time required for recording the RAW image data; time required for the processing instep S213) can be reduced to a time that is shorter than the recording time required for the singles shooting. As a result, the consecutive shooting speed can be improved. In other words, the time interval of a plurality of photographing (photographing to record the imaging data), which are performed consecutively, can be reduced, and a number of times of photographing per unit time can be increased. Further, by decreasing the data size of the RAW image data that is recorded in consecutive shooting, a number of RAW image data that can be stored to the buffer 115 can be increased, and a number of times of shooting which can be executed in the consecutive shooting, and a number of RAW image data that can be recorded in the consecutive shooting and the like can also be increased.

In this embodiment, the example of compressing the RAW image data, even in the single shooting, was described, but the present invention is not limited to this. For example, in the single shooting, the RAW image data outputted from the sensor signal processing unit 103 may be used as the record RAW image data. In concrete terms, the RAW image data outputted from the sensor signal processing unit 103 may be used as the RAW image data after the Lossless compression. In this case, the Lossless compression need not be performed.

If the buffer 115 has sufficient storage capacity, the processing in step S213 may be performed later. Thereby the consecutive shooting speed can be further improved. In concrete terms, the processing in step S213 is omitted in a period when a predetermined number of times of imaging (generation of a predetermined number of record RAW image data) is performed in accordance with the storage capacity of the buffer 115, whereby the time interval of the predetermined number of times of imaging can be reduced. The omitted processing in step S213 (plurality of times of processing) can be executed in batch after the predetermined number of times of imaging are performed.

In this embodiment, an example of performing the consecutive shooting or the single shooting was described, but photographing that is different from these two may be performed. For example, a bracket photographing may be performed. In the bracket photographing, a plurality of times of photographing is performed consecutively under different imaging conditions (e.g. shutter speed, diaphragm, ISO sensitivity, focal length). The intended use of the plurality of imaging data acquired by the bracket photographing is not especially limited. For example, imaging data having a dynamic range that is wider than the dynamic range of each imaging data may or may not be generated by composing a plurality of imaging data. A wide dynamic range is called “high dynamic range (HDR)”, and the above mentioned composition is called “HDR composition”. The bracket photographing to acquire a plurality of imaging data for HDR composition is called “HDR photographing”. In HDR photographing, for instance a plurality of times of photographing is performed consecutively under mutually different exposure conditions.

In the bracket photographing (including HDR photographing), a plurality of times of imaging can be performed at a fast consecutive shooting speed. In concrete terms, a number of times of photographing is relatively low in the bracket photographing, therefore if the bracket photographing is used, all the record RAW image data can be stored to the buffer 115 first, then the record RAW image data can be stored in the storage unit. By using such a configuration, the consecutive shooting speed of the bracket photographing can be improved. In a case where the bracket photographing is performed, it is preferable to perform the same processing as the processing in the case where the single shooting is performed (e.g. not compressing the RAW image data, compressing the RAW image data at a compression ratio that is lower than the compression ratio in consecutive shooting). The compression ratio (compression ratio applied to the RAW image data) in the bracket photographing may be the same as the compression ratio in the single shooting, or may be different from the compression ratio in the single shooting.

### Embodiment 2

Embodiment 2 of the present invention will be described. In this embodiment, an example in which the value of the compression ratio R_Lossy, which is applied to the RAW image data in the consecutive shooting, is appropriately changed, will be described. Description on aspects (configuration, processing) that are the same as Embodiment 1 will be omitted, and aspects that are different from Embodiment 1 will be described in detail. The configuration of an imaging apparatus according to this embodiment is the same as the configuration according to Embodiment 1 (FIG. 1).

In this embodiment, the RAW compression unit 113 changes the value of the compression ratio R_Lossy, in accordance with the change of the information on the recording of the image data (imaging data) in the storage unit (recording medium 152 or external device). The information on recording (recording information) is not especially limited, but, for example, the setting of the recording mode to record in the storage unit the imaging data, the parameters of the developed image data, the recording speed which is a speed to record in the storage unit the image data and the like are used as the recording information. “recording speed” is also called “transfer speed, which is a speed to transfer the image data to the storage unit”.

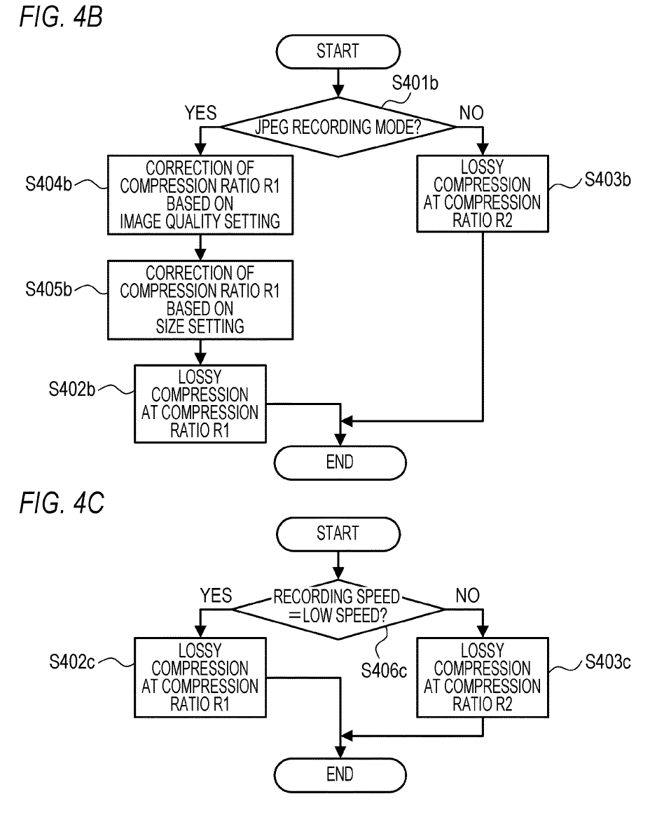

FIG. 4A to FIG. 4C are flow charts depicting the RAW compression according to this embodiment. The processing operations in FIG. 4A to FIG. 4C are performed, for example, in a case where the consecutive shooting mode is set, or a case where the consecutive shooting is performed. For example, the processing operations in FIG. 4A to FIG. 4C are performed at the timing in step S302 in FIG. 3. The processing in FIG. 4A, the processing in FIG. 4B and the processing in FIG. 4C may be appropriately combined.

FIG. 4A is an example in which the setting of the recording mode is used as the recording information. First in step S401a, the control unit 161 determines whether the currently set recording mode is the RAW recording mode or the JPEG recording mode. If the currently set recording mode is the JPEG recording mode, processing advances to step S402a, and if the currently set recording mode is the RAW recording mode, processing advances to step S403a.

The JPEG recording mode is a first recording mode, in which the JPEG image data (developed image data compressed by the JPEG method) is recorded in the storage unit, instead of the record RAW image data. Hence if the JPEG recording method is set, the processing in step S213 in FIG. 2 is omitted. The RAW recording mode is a second recording mode, in which the record RAW image data is recorded in the storage unit. In a case where the RAW recording mode is set, the processing in step S211 and the processing in step S212 may or may not be omitted. The developed image data recorded in the first recording mode is not limited to the JPEG image data.

In step S402a, the Lossy compression unit 116 compresses the RAW image data, repaired in step S202, at the compression ratio R_Lossy=R1. In step S403a, the Lossy compression unit 116 compresses the RAW image data, repaired in step S202, at the comparison ratio R_Lossy=R2.

Even if the compression ratio R_Lossy is increased, the image quality of the developed image data does not drop very much. For example, in the case of the JPEG type compression, the high frequency components and the low amplitude components are deleted (reduced). Hence, even if Lossy compression is performed to considerably decrease the data size of the high frequency components and the low amplitude components at a high compression ratio R_Lossy, the image quality of the JPEG image data does not drop very much. Therefore in this embodiment, a compression ratio that is higher than the compression ratio R_Lossy=R2 is used for the compression ratio R_Lossy=R1.

Thereby, for instance further improvement of the consecutive shooting speed and further improvement of the number of consecutive shots can be provided. For example, in a case where the JPEG recording mode is set, the data size of the RAW image data after compression can be reduced, and a number of RAW image data that can be stored to the buffer 115 can be increased. As a result, since, after the compressed RAW image data is stored to the buffer 115, each RAW image data is read from the buffer 115 and developed, the processing time required for the development processing can be decreased, and the consecutive shooting speed can be further improved.

FIG. 4B is an example in which the setting of the recording mode and the parameters of the developed image data are used as the recording information. Here, as the developed image data, the development unit 110 generates image data having the parameters which are set. The parameters are set in accordance with the operation mode of the imaging apparatus 100, the user operation and the like. FIG. 4B is an example in which the image size and the image quality are used as the parameters of the developed image data. The parameters of the developed image data are not especially limited, as long as the parameters are related to the data size of the image data. For example, one of the image size and the image quality may be used as a parameter of the developed image data. A number of bits (gradation number) or the like may be used as a parameter of the developed image data.

The processing in step S401b is the same as the processing in step S401a, the processing in step S402b is the same as the processing in step S402a, and the processing in step S403b is the same as the processing in step S403a. If the currently set recording mode is the JPEG recording mode, processing advances from step S401b to step S404b.

In step S404b, the Lossy compression unit 116 corrects the value of the compression ratio R_Lossy=R1 based on the currently set image quality (image quality setting). If the image quality setting is low, the developed image data that is generated and recorded has an image quality that is lower than the image quality of the developed image data that is generated and recorded in a case where the image quality setting is high. Further, if the image quality setting is low, the developed image data that is generated and recorded has a data size that is smaller than the data size of the developed image data that is generated and recorded in a case where the image quality setting is high. If the image quality setting is low, the image quality of the developed image data does not drop very much, even if the compression ratio R_Lossy is increased. For example, if the image quality setting is low, coarse quantization is performed during the JPEG type compression. Therefore in the compression of the RAW image data, it is not overly necessary to perform high resolution quantization in a case where the RAW image data is compressed. Further, the image quality of the JPEG image data does not drop very much, even if coarse quantization is performed by Lossy compression at a high compression ratio R_Lossy. Therefore in step S404b, if the image quality setting is low, the compression ratio R_Lossy=R1 is corrected to a higher compression ratio compared with the compression ratio R_Lossy=R1 in the case of a high image quality setting. For example, the compression ratio R_Lossy=R1 is increased at an increase amount that is larger as the image quality setting is lower.

The initial value of the compression ratio R_Lossy=R1 is not especially limited. The way of increasing the compression ratio R_Lossy=R1 in step S404b is not especially limited. Here a case where the Lossy compression includes a discrete cosine transform (DCT) is considered. In this case, the method of expanding the quantization scale of the DCT coefficient can be used to increase the compression ratio R_Lossy=R1 in step S404b. By expanding the quantization scale of the DCT coefficient, the quantization of the DCT coefficient can be made more coarse, and the compression ratio R_Lossy=R1 can be increased.

In step S405b, the Lossy compression unit 116 corrects the value of the compression ratio R_Lossy=R1 generated in the processing in step S404b, based on the image size that is set (size setting). If the size setting is small, the developed image data that is generated and recorded has an image size that is smaller than the image size of the developed image data that is generated and recorded in a case where the size setting is large. Further, if the size setting is small, the developed image data that is generated and recorded has the data size that is smaller than the data size of the developed image data that is generated and recorded in a where the size setting is large. If the size setting is small, the image quality of the developed image data does not drop very much, even if the compression ratio R_Lossy is increased. For example, if the size setting is small, the high frequency components are deleted (reduced) because the image size is reduced. Therefore, necessity to keep high frequency components, in a case where the RAW image data is compressed, is low. Further, image quality of the developed image data does not drop very much, even if the high frequency components are considerably decreased by the Lossy compression at a high compression ratio R_Lossy. Therefore in step S405b, if the size setting is small, the compression ratio R_Lossy=R1 is corrected to a higher compression ratio compared with the compression ratio R_Lossy=R1 in the case of the large size setting. For example, the compression ratio R_Lossy=R1 is increased at an increase amount that is larger as the size setting is smaller.

The way of increasing the compression ratio R_Lossy=R1 in step S405b is not especially limited either. Here a case where the Lossy compression includes a discrete cosine transform (DCT) is considered. In this case, the method of increasing the element values corresponding to the high frequency components, out of a plurality of element values of the quantization matrix used for quantizing the DCT coefficient, can be used to increase the compression ratio R_Lossy=R1 in step S405b. By increasing the element values corresponding to the high frequency components, the quantization of the DCT coefficient can be made more coarse, and the compression ratio R_Lossy=R1 can be increased. To increase the compression ratio R_Lossy=R1 in step S405b, the method of expanding the quantization scale may be used.

After step S405b, processing advances to step S402b. In step S402b, the Lossy compression is performed at the compression ratio R_Lossy=R1, in which the processing in step S404b and the processing is step S405b are reflected. The processing in step S405b may be performed after the processing in step S404b.

Here a case where the JPEG recording mode is set is considered. According to the processing in FIG. 4B, if the data size related to the parameters being set is small, a compression ratio that is higher than the case where the data size related to the parameters being set is large is used as the final compression ratio R_Lossy=R1. Thereby, for instance a consecutive shooting speed that is faster than the consecutive shooting speed that can be implemented in the processing in FIG. 4A, and a number of consecutive shots that is higher than the number of consecutive shots that can be implemented in the processing in FIG. 4A can be implemented.

FIG. 4C is an example in which the recording speed (speed of recording the image data in the storage unit used for photographing) is used as the recording information. First in step S406c, the control unit 161 determines whether or not the recording speed is low speed. If the recording speed is low speed, processing advances to step S402c, and if the recording speed is not low speed, processing advances to step S403c. The processing in step S402c is the same as the processing in steps S402a and S402b, and the processing in step S403c is the same as the processing in step S403a and S403b.

The method of determining whether or not the recording speed is low speed is not especially limited. The recording speed depends on the type of the storage unit, the specifications of the storage unit and the like. Therefore the correspondence between such information as the type of the storage unit and the specifications of the storage unit, and information whether or not the recording speed is low speed, can be determined in advance. Then using these correspondences, whether or not the recording speed is low speed can be determined in accordance with the type of the storage unit used for the photographing, the specifications of the storage unit used for the photographing and the like. Further, the correspondences between such information as the type of the storage unit and the specifications of the storage unit and the recoding speed may be determined in advance. Then using these correspondences, the recording speed can be determined in accordance with the type of the storage unit used for the photographing, the specifications of the storage unit used for the photographing and the like. And based on the determined recording speed, whether or not the recording speed is low speed can be determined. For example, it is determined that “the recording speed is low speed” in a case where the determined recording speed is less than a threshold, and it is determined that “the recording speed is not low speed (the recording speed is high speed)” in a case where the determined recording speed is a threshold or more. The time required for recording test data in the storage unit may be measured, so that the recording speed is determined based on this measurement result.

In a case where the recording speed is slow, the data size of the imaging data to be recorded (record RAW image data) must be sufficiently reduced in order to implement a sufficiently fast consecutive shooting speed. According to the processing in FIG. 4C, in a case where the recording speed is slow, a compression ratio, which is higher than the case where the recording speed is fast, is used as the compression ratio R_Lossy. Thereby, for instance the consecutive shooting speed can be further improved, and the number of consecutive shots can be further increased. For example, even if the recording speed is slow, a sufficiently fast consecutive shooting speed can be implemented. In FIG. 4C, two patterns (a pattern in a case where the recording speed is slow, and a pattern in a case where the recording speed is not slow) are depicted, but the present invention is not limited to this. For example, the value of the compression ratio R_Lossy may be changed in a number of patterns that are more than 2, so that a high compression ratio is used for the compression ratio R_Lossy as the recording speed is slower.

As described above, according to this embodiment, the value of the compression ratio R_Lossy is changed in accordance with the change of the recording information. Thereby, for instance the consecutive shooting speed can be further improved, and a number of consecutive shots can be further increased. In the processing in step S403a, the processing in step S403b and the processing in step S403c, a value the same as the compression ratio R_Lossless of the Lossless compression may be used as the value of the compression ratio R_Lossy. In this case, the processing in step S403a, the processing in step S403b and the processing in step S403c maybe executed by the Lossless compression unit 117.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to readout and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-118042, filed on Jun. 14, 2016, which is hereby incorporated by reference herein in its entirety.

What is claimed is:

1. An imaging apparatus, comprising:
an imaging unit configured to generate RAW image data by imaging;
a generation unit configured to generate record RAW image data from the RAW image data; and
a recording unit configured to record in a storage unit the record RAW image data, wherein
the generation unit
generates the record RAW image data by performing Lossy compression on the RAW image data in a case where consecutive shooting is performed, and
generates the record RAW image data by performing Lossless compression on the RAW image data in a case where single shooting or bracket photographing is performed.

2. The imaging apparatus according to claim 1, wherein
a compression ratio of the Lossy compression is higher than a compression ratio of the Lossless compression.

3. The imaging apparatus according to claim 1, wherein
the generation unit comprises:
a first compression unit configured to perform the Lossy compression; and
a second compression unit configured to perform the Lossless compression.

4. The imaging apparatus according to claim 1, wherein
the generation unit changes a compression ratio of the Lossy compression in accordance with a change of information on recording in the storage unit image data.

5. The imaging apparatus according to claim 1, further comprising a development unit configured to generate developed image data from the record RAW image data by performing development processing, wherein
in a case where a first recording mode, in which the recording unit records in the storage unit the developed image data instead of the record RAW image data, is set, the generation unit uses, as a compression ratio of the Lossy compression, a higher compression ratio than in a case where a second recording mode, in which the recording unit records in the storage unit the record RAW image data, is set.

6. The imaging apparatus according to claim 5, wherein
the development unit generates image data having set parameters as the developed image data,
the parameters are related to a data size of the image data, and
in a case where the first recording mode is set and the data size related to the set parameters is large, the generation unit uses, as a compression ratio of the Lossy compression, a lower compression ratio than in a case where the first recording mode is set and the data size related to the set parameters is small.

7. The imaging apparatus according to claim 6, wherein
the parameters include at least one of image size and image quality.

8. The imaging apparatus according to claim 1, wherein
in a case where a recording speed, which is a speed of recording in the storage unit image data, is slow, the generation unit uses, as a compression ratio of the Lossy compression, a higher compression ratio than in a case where the recording speed is fast.

9. An imaging method, comprising:
generating RAW image data by imaging;
generating record RAW image data from the RAW image data; and
recording in a storage unit the record RAW image data, wherein
the record RAW image data is generated by performing Lossy compression on the RAW image data in a case where consecutive shooting is performed, and
the record RAW image data is generated by performing Lossless compression on the RAW image data in a case where single shooting or bracket photographing is performed.

10. Anon-transitory computer readable medium that stores a program, wherein
the program causes a computer to execute:
generating RAW image data by imaging;
generating record RAW image data from the RAW image data; and
recording in a storage unit the record RAW image data,
the record RAW image data is generated by performing Lossy compression on the RAW image data in a case where consecutive shooting is performed, and
the record RAW image data is generated by performing Lossless compression on the RAW image data in a case where single shooting or bracket photographing is performed.
